(19) United States
(12) Patent Application Publication
(10) Pub. No.: US 2024/0410136 A1
(43) Pub. Date: Dec. 12, 2024

(54) CONTROL SYSTEM OF WORK MACHINE, WORK MACHINE, AND METHOD OF CONTROLLING WORK MACHINE

(71) Applicant: Komatsu Ltd., Tokyo (JP)

(72) Inventors: Shogo Atsumi, Tokyo (JP); Shoji Sonoyama, Tokyo (JP); Toshihide Mineushiro, Tokyo (JP); Taiki Sugawara, Tokyo (JP); Toyohisa Matsuda, Tokyo (JP)

(73) Assignee: Komatsu Ltd., Tokyo (JP)

(21) Appl. No.: 18/576,114

(22) PCT Filed: Jul. 1, 2022
(86) PCT No.: PCT/JP2022/026480

§ 371 Date: Aug. 14, 2024

(30) Foreign Application Priority Data
Jul. 8, 2021 (JP) 2021-113848

(51) Int. Cl. E02F 9/26; G01C 9/02; G01S 19/48

(52) U.S. Cl. CPC E02F 9/26; G01C 9/02; G01S 19/485

(57) ABSTRACT

A control system of a work machine includes a first position/azimuth calculation unit that calculates a position and an azimuth angle of the work machine based on a GNSS radio wave, a second position/azimuth calculation unit that calculates the position and the azimuth angle of the work machine based on an image of a plurality of targets installed on the outside of the work machine, and a switching unit that switches a first calculation mode in which the first position/azimuth calculation unit calculates the position and the azimuth angle of the work machine and a second calculation mode in which the second position/azimuth calculation unit calculates the position and the azimuth angle of the work machine.

### FIELD

The present disclosure relates to a control system of a work machine, a work machine, and a method of controlling a work machine.

### BACKGROUND

In a technical field relating to a work machine, a technique for excavating an excavation target based on a target construction surface disclosed in Patent Literature 1 has been known. As a technique for excavating an excavation target based on a target construction surface, there has been known a machine guidance technique for presenting a guidance image indicating relative positions of a target construction surface and working equipment to an operator of a work machine and a machine control technique for assisting and controlling operation of an operator such that working equipment operates according to a target construction surface.

### CITATION LIST

### Patent Literature

Patent Literature 1: WO 2015/167022 A

### SUMMARY

### Technical Problem

When an excavation target is excavated based on a target construction surface, it is necessary to calculate a position and an azimuth angle of a work machine. The position and the azimuth angle of the work machine are calculated using a global navigation satellite system (GNSS). When a positioning failure of the GNSS occurs, it is difficult to calculate the position and the azimuth angle of the work machine.

An object of the present disclosure is to calculate a position and an azimuth angle of a work machine when a positioning failure of a GNSS occurs.

### Solution to Problem

According to an aspect of the present invention, a control system of a work machine, comprises: a first position/azimuth calculation unit that calculates a position and an azimuth angle of the work machine based on a GNSS radio wave; a second position/azimuth calculation unit that calculates the position and the azimuth angle of the work machine based on an image of a plurality of targets installed on an outside of the work machine; and a switching unit that switches a first calculation mode in which the first position/azimuth calculation unit calculates the position and the azimuth angle of the work machine and a second calculation mode in which the second position/azimuth calculation unit calculates the position and the azimuth angle of the work machine.

### Advantageous Effects of Invention

According to the present disclosure, a position and an azimuth angle of a work machine are calculated when a positioning failure of a GNSS occurs.

### BRIEF DESCRIPTION OF DRAWINGS

FIG. 1 is a perspective view illustrating a work machine according to an embodiment.

FIG. 2 is a schematic diagram illustrating the work machine according to the embodiment.

FIG. 3 is a diagram illustrating a cab of the work machine according to the embodiment.

FIG. 4 is a block diagram illustrating a control system of the work machine according to the embodiment.

FIG. 5 is a schematic diagram for explaining a calculation mode of a position and an azimuth angle of a turning body according to the embodiment.

FIG. 6 is a diagram illustrating a plurality of targets installed in a work site according to the embodiment.

FIG. 7 is a diagram illustrating a target according to the embodiment.

FIG. 8 is a flowchart illustrating a method of calculating a position and an azimuth angle of the turning body according to the embodiment.

FIG. 9 is a schematic diagram for explaining the method of calculating a position and an azimuth angle of the turning body according to the embodiment.

FIG. 10 is a schematic diagram for explaining the method of calculating a position and an azimuth angle of the turning body according to the embodiment.

FIG. 11 is a flowchart illustrating a method of calculating a position and an azimuth angle of the turning body after the turning body has performed a turning motion according to the embodiment.

FIG. 12 is a flowchart illustrating a method of correcting a calculation result of the position and the azimuth angle of the turning body according to the embodiment.

FIG. 13 is a block diagram illustrating a computer system according to the embodiment.

### DESCRIPTION OF EMBODIMENT

An embodiment according to the present disclosure is explained with reference to the drawings. However, the present disclosure is not limited to the embodiment. Constituent elements of the embodiment explained below can be combined as appropriate. A part of the constituent elements is sometimes not used.

### [Work Machine]

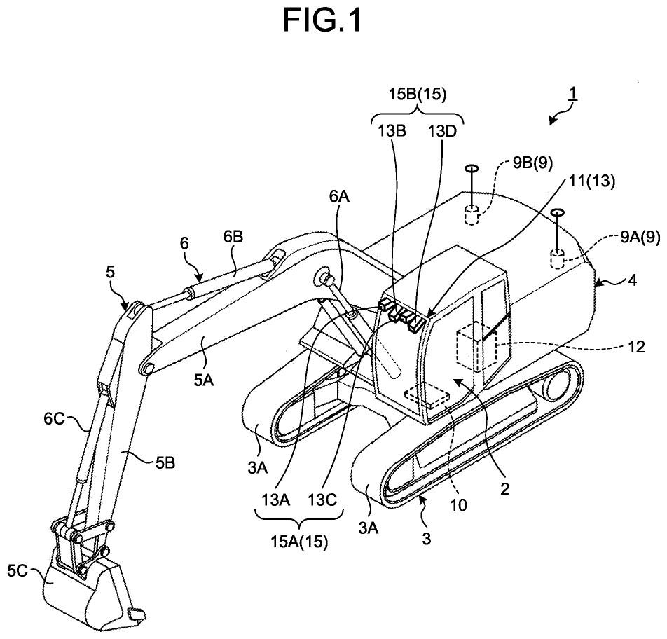

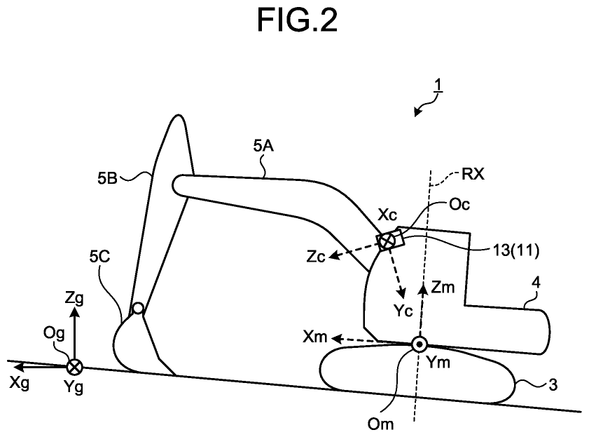

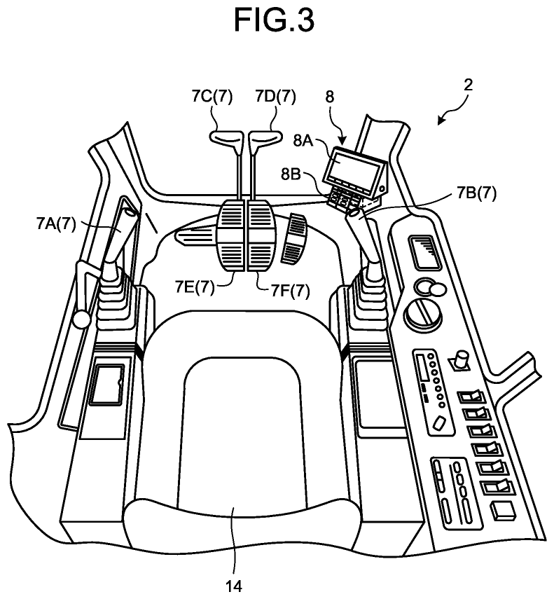

FIG. 1 is a perspective view illustrating a work machine 1 according to an embodiment. FIG. 2 is a schematic diagram illustrating the work machine 1 according to the embodiment. FIG. 3 is a diagram illustrating a cab 2 of the work machine 1 according to the embodiment.

The work machine 1 operates at a work site. In the embodiment, the work machine 1 is an excavator. In the following explanation, the work machine 1 is referred to as excavator 1 as appropriate.

The excavator 1 includes a traveling body 3, a turning body 4, working equipment 5, a hydraulic cylinder 6, an operation device 7, an in-vehicle monitor 8, a position sensor 9, an inclination sensor 10, an imaging device 11, and a control device 12.

As illustrated in FIG. 2, a three-dimensional site coordinate system (Xg, Yg, Zg) is defined in the work site. A three-dimensional vehicle body coordinate system (Xm, Ym, Zm) is defined in the turning body 4. A three-dimensional camera coordinate system (Xc, Yc, Zc) is defined in the imaging device 11.

The site coordinate system is configured by an Xg axis extending from a site reference point Og defined at the work site to the north and the south, a Yg axis extending from the site reference point Og to the east and the west, and a Zg axis extending from the site reference point Og to the top and the bottom.

The vehicle body coordinate system is configured by an Xm axis extending in the front-rear direction of the turning body 4 from a representative point Om defined in the turning body 4, a Ym axis extending in the left-right direction of the turning body 4 from the representative point Om, and a Zm axis extending in the up-down direction of the turning body 4 from the representative point Om. With the representative point Om of the turning body 4 set as a reference, the +Xm direction is the forward direction of the turning body 4, the −Xm direction is the rearward direction of the turning body 4, the +Ym direction is the left direction of the turning body 4, the −Ym direction is the right direction of the turning body 4, the +Zm 10 direction is the upward direction the turning body 4, and the −Zm direction is the downward direction the turning body 4.

The camera coordinate system is configured by an Xc axis extending from an optical center Oc of one camera 13 configuring the imaging device 11 in the width direction of the camera 13, a Yc axis extending from the optical center Oc in the up-down direction of the camera 13, and a Zc axis extending from the optical center Oc in a direction parallel to the optical axis of an optical system of the camera 13.

The traveling body 3 travels in a state in which the traveling body 3 supports the turning body 4. The traveling body 3 includes a pair of crawler belts 3A. The traveling body 3 performs a traveling motion according to rotation of the crawler belts 3A. The traveling motion of the traveling body 3 includes a forward motion and a backward motion. The excavator 1 can move in the work site with the traveling body 3.

The turning body 4 is supported by the traveling body 3. The turning body 4 is disposed above the traveling body 3. The turning body 4 performs a turning motion centering on the turning axis RX in a state in which the turning body 4 is supported by the traveling body 3. The turning axis RX is parallel to the Zm axis. The turning motion of the turning body 4 includes a left turning motion and a right turning motion. The cab 2 is provided in the turning body 4.

The working equipment 5 is supported by the turning body 4. The working equipment 5 implements work. In the embodiment, the work implemented by the working equipment 5 includes excavation work for excavating an excavation target and loading work for loading an excavated object onto a loading target.

The working equipment 5 includes a boom 5A, an arm 5B, and a bucket 5C. The proximal end portion of the boom 5A is turnably coupled to a front portion of the turning body 4. The proximal end portion of the arm 5B is turnably coupled to the distal end portion of the boom 5A. The proximal end portion of the bucket 5C is turnably coupled to the distal end portion of the arm 5B.

The hydraulic cylinder 6 causes the working equipment 5 to operate. The hydraulic cylinder 6 includes a boom cylinder 6A, an arm cylinder 6B, and a bucket cylinder 6C. The boom cylinder 6A causes the boom 5A to perform a raising motion and a lowering motion. The arm cylinder 6B causes the arm 5B to perform an excavating motion and a dumping motion. The bucket cylinder 6C causes the bucket 5C to perform an excavating motion and a dumping motion. The proximal end portion of the boom cylinder 6A is coupled to the turning body 4. The distal end portion of the boom cylinder 6A is coupled to the boom 5A. The proximal end portion of the arm cylinder 6B is coupled to the boom 5A. The distal end portion of the arm cylinder 6B is coupled to the arm 5B. The proximal end portion of the bucket cylinder 6C is coupled to the arm 5B. The distal end portion of the bucket cylinder 6C is coupled to the bucket 5C.

As illustrated in FIG. 3, the operation device 7 is disposed in the cab 2. The operation device 7 is operated to cause at least one of the traveling body 3, the turning body 4, and the working equipment 5 to operate. The operation device 7 is operated by an operator riding in the cab 2. The operator can operate the operation device 7 in a state in which the operator is seated on a driver's seat 14 disposed in the cab 2.

The operation device 7 includes a left work lever 7A and a right work lever 7B operated for motions of the turning body 4 and the working equipment 5, a left traveling lever 7C and a right traveling lever 7D operated for a motion of the traveling body 3, and a left foot pedal 7E and a right foot pedal 7F.

When the left work lever 7A is operated in the front-rear direction, the arm 5B performs a dumping motion or an excavating motion. The left work lever 7A is operated in the left-right direction, whereby the turning body 4 performs the left turning motion and the right turning operation. The right work lever 7B is operated in the left-right direction, whereby the bucket 5C performs the excavating motion or the dumping motion. The right work lever 7B is operated in the front-rear direction, whereby the boom 5A is performs the lowering motion or the raising motion. Note that the turning body 4 may perform the right turning motion or the left turning motion when the left work lever 7A is operated in the front-rear direction and the arm 5B may perform the dumping motion or the excavating motion when the left work lever 7A is operated in the left-right direction.

The left traveling lever 7C is operated in the front-rear direction, whereby a crawler belt 3A on the left side of the traveling body 3 performs the forward motion or the backward motion. The right traveling lever 7D is operated in the front-rear direction, whereby the crawler belt 3A on the right side of the traveling body 3 performs the forward motion or the backward motion.

The left foot pedal 7E interlocks with the left traveling lever 7C. The right foot pedal 7F interlocks with the right traveling lever 7D. The left foot pedal 7E and the right foot pedal 7F are operated, whereby the traveling body 3 may perform the forward motion or the backward motion.

The in-vehicle monitor 8 is disposed in the cab 2. The in-vehicle monitor 8 is disposed in the right front of the driver's seat 14. The in-vehicle monitor 8 includes a display device 8A and an input device 8B.

The display device 8A displays prescribed display data. Examples of the display device 8A include a flat panel display such as a liquid crystal display (LCD) or an organic electroluminescence display (OELD).

The input device 8B generates input data by being operated by the operator. Examples of the input device 8B include a button switch, a computer keyboard, and a touch panel.

The position sensor 9 detects a position in the site coordinate system. The position sensor 9 detects a position in the site coordinate system using a global navigation satellite system (GNSS). The global navigation satellite system includes a global positioning system (GPS). The global navigation satellite system detects a position defined by coordinate data of latitude, longitude, and altitude. The position sensor 9 includes a GNSS receiver that receives GNSS radio waves from a GNSS satellite. The position sensor 9 is disposed in the turning body 4. In the embodiment, the position sensor 9 is disposed in the counterweight of the turning body 4.

The position sensor 9 includes a first position sensor 9A and a second position sensor 9B. The first position sensor 9A and the second position sensor 9B are disposed in different positions of the turning body 4. In the embodiment, the first position sensor 9A and the second position sensor 9B are disposed at intervals in the left-right direction in the turning body 4. The first position sensor 9A detects a first positioning position indicating a position where the first position sensor 9A is disposed. The second position sensor 9B detects a second positioning position indicating a position where the second position sensor 9B is disposed.

The inclination sensor 10 detects acceleration and angular velocity of the turning body 4. The inclination sensor 10 includes an inertial measurement unit (IMU). The inclination sensor 10 is disposed in the turning body 4. In the embodiment, the inclination sensor 10 is installed below the cab 2.

The imaging device 11 images the front of the turning body 4. The imaging device 11 is disposed in the turning body 4. In the embodiment, the imaging device 11 is disposed in an upper part of the cab 2. The imaging device 11 includes a plurality of cameras 13. The cameras 13 include optical systems and image sensors that receive light via the optical systems. Examples of the image sensors include a CCD (Charge Coupled Device) sensor and a CMOS (Complementary Metal Oxide Semiconductor) sensor.

In the embodiment, four cameras 13 are provided. The cameras 13 include a camera 13A, a camera 13B, a camera 13C, and a camera 13D. A stereo camera 15 is configured by a set of cameras 13. In the embodiment, a first stereo camera 15A is configured by a set of cameras 13A and 13C. A second stereo camera 15B is configured by a set of cameras 13B and 13D.

The camera 13A and the camera 13C of the stereo camera 15A are disposed at intervals in the left-right direction of the turning body 4. The camera 13B and the camera 13D of the stereo camera 15B are disposed at intervals in the left-right direction of the turning body 4. The optical axes of the optical systems of the cameras 13A and 13C are substantially parallel to the Xg axis. The optical axes of the optical systems of the cameras 13B and 13D are inclined downward toward the front of the turning body 4.

### [Control System]

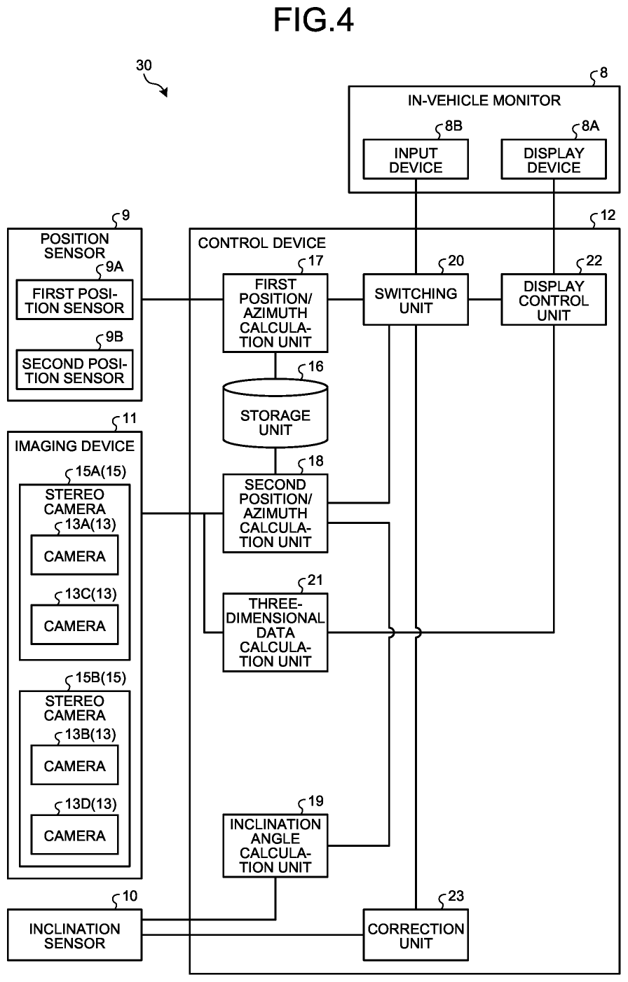

FIG. 4 is a block diagram illustrating a control system 30 of the work machine 1 according to the embodiment. The excavator 1 includes the control system 30. The control system 30 includes the in-vehicle monitor 8, the position sensor 9, the inclination sensor 10, the imaging device 11, and the control device 12. The control device 12 controls the excavator 1. The control device 12 includes a computer system.

The control device 12 includes a storage unit 16, a first position/azimuth calculation unit 17, a second position/azimuth calculation unit 18, an inclination angle calculation unit 19, a switching unit 20, a three-dimensional data calculation unit 21, a display control unit 22, and a correction unit 23.

The storage unit 16 stores prescribed storage data. The storage unit 16 stores target data relating to a target 24 explained below. A plurality of targets 24 are installed on the outside of the excavator 1. The target data includes a three-dimensional position of each of the plurality of targets 24. The target data includes correlation data indicating a relation between identification data defined by an identification mark 27 of the target 24 and a three-dimensional position of the target 24.

The first position/azimuth calculation unit 17 calculates a position and an azimuth angle of the turning body 4 in the site coordinate system based on detection data of the position sensor 9. As explained above, the position sensor 9 includes a GNSS receiver that receives GNSS radio waves. The first position/azimuth calculation unit 17 calculates a position and an azimuth angle of the turning body 4 based on the GNSS radio waves. The azimuth angle of the turning body 4 is, for example, an azimuth angle of the turning body 4 based on the Xg axis.

The first position/azimuth calculation unit 17 calculates the position of the turning body 4 based on at least one of a first positioning position detected by the first position sensor 9A and a second positioning position detected by the second position sensor 9B. The first position/azimuth calculation unit 17 calculates the azimuth angle of the turning body 4 based on relative positions of the first positioning position detected by the first position sensor 9A and the second positioning position detected by the second position sensor 9B.

The second position/azimuth calculation unit 18 calculates the position and the azimuth angle of the turning body 4 in the site coordinate system based on an image acquired by the imaging device 11. As explained above, the plurality of targets 24 are installed on the outside of the excavator 1. The imaging device 11 images the targets 24. The second position/azimuth calculation unit 18 acquires an image of the plurality of targets 24 from the imaging device 11. The second position/azimuth calculation unit 18 calculates the position and the azimuth angle of the turning body 4 based on the image of the plurality of targets 24 installed on the outside of the excavator 1.

The inclination angle calculation unit 19 calculates an inclination angle of the turning body 4 based on detection data of the inclination sensor 10. The inclination angle of the turning body 4 includes a roll angle and a pitch angle of the turning body 4. The roll angle means an inclination angle of the turning body 4 in an inclination direction centering on the Xg axis. The pitch angle means an inclination angle of the turning body 4 in an inclination direction centering on the Yg axis. The inclination angle calculation unit 19 calculates the roll angle and the pitch angle of the turning body 4 based on the detection data of the inclination sensor 10.

The switching unit 20 switches a first calculation mode in which the first position/azimuth calculation unit 17 calculates the position and the azimuth angle of the turning body 4 and a second calculation mode in which the second position/azimuth calculation unit 18 calculates the position and the azimuth angle of the turning body 4.

The three-dimensional data calculation unit 21 calculates a distance between the stereo camera 15 and an imaging target based on a set of images captured by the stereo camera 15. Examples of the imaging target include an excavation target to be excavated by the working equipment 5. The three-dimensional data calculation unit 21 calculates three-dimensional data of the imaging target by stereoscopically processing images of the same imaging target captured by a set of cameras 13 of the stereo camera 15. The three-dimensional data calculation unit 21 calculates three-dimensional data in the camera coordinate system.

The display control unit 22 controls the display device 8A of the in-vehicle monitor 8. The display control unit 22 causes the display device 8A to display prescribed display data.

The correction unit 23 corrects an error of the inclination sensor 10.

### [Calculation Mode]

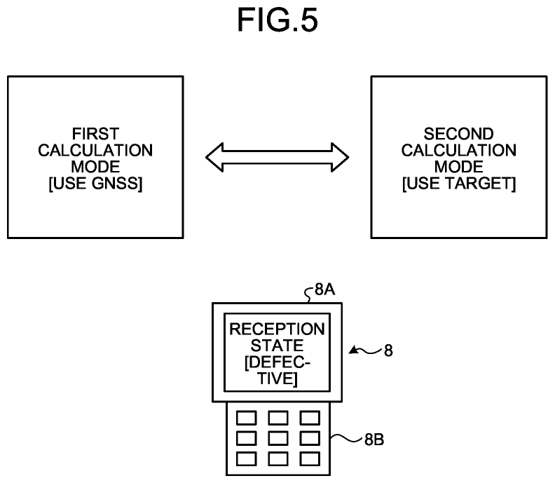

FIG. 5 is a schematic diagram for explaining a calculation mode for a position and an azimuth angle of the turning body 4 according to the embodiment. In the embodiment, the position and the azimuth angle of the turning body 4 are calculated in at least one of a first calculation mode and a second calculation mode. The position of the turning body 4 includes the position of the representative point Om of the turning body 4 in the site coordinate system. The azimuth angle of the turning body 4 includes the azimuth angle of the vehicle body coordinate system based on the representative point Om of the turning body 4 in the site coordinate system.

The first calculation mode is a calculation mode for calculating the position and the azimuth angle of the turning body 4 based on a GNSS radio wave. In the first calculation mode, the first position/azimuth calculation unit 17 calculates the position and the azimuth angle of the turning body 4 based on detection data of the position sensor 9.

The second calculation mode is a calculation mode for calculating the position and the azimuth angle of the turning body 4 based on an image of the plurality of targets 24. In the second calculation mode, the second position/azimuth calculation unit 18 calculates the position and the azimuth angle of the turning body 4 based on the image of the targets 24 captured by the imaging device 11.

When a positioning failure of the GNSS occurs, it is likely that it is difficult to calculate the position and the azimuth angle of the turning body 4 with the first position/azimuth calculation unit 17. The positioning failure of the GNSS includes a decrease in positioning accuracy and positioning inability of the GNSS. Examples of the positioning failure of the GNSS include insufficient strength of the GNSS radio wave received by the position sensor 9 or multipath of the GNSS radio wave. The multipath of the GNSS radio wave means a phenomenon in which a GNSS radio wave transmitted from a GNSS satellite is reflected on a ground, a building, or the like or is reflected or refracted in an ionosphere and the position sensor 9 receives GNSS radio waves from a plurality of transmission paths, whereby an error occurs in a detected position.

When no positioning failure of the GNSS occurs, the position and the azimuth angle of the turning body 4 are calculated in the first calculation mode. When a positioning failure of the GNSS occurs, the position and the azimuth angle of the turning body 4 are calculated in the second calculation mode.

The switching unit 20 switches the first calculation mode and the second calculation mode based on a reception state of the GNSS radio wave. The first position/azimuth calculation unit 17 can determine whether a reception state of the GNSS radio wave is good or bad. The first position/azimuth calculation unit 17 can determine, for example, the intensity of the GNSS radio wave. The switching unit 20 switches the first calculation mode and the second calculation mode based on a reception state of the GNSS radio wave by the position sensor 9. The switching unit 20 switches the first calculation mode and the second calculation mode based on whether the first position/azimuth calculation unit 17 can calculate the position and the azimuth angle of the turning body 4. For example, when the intensity of the GNSS radio wave is insufficient and the reception state of the GNSS radio wave is bad, it is highly likely that the first position/azimuth calculation unit 17 falls into a state in which the first position/azimuth calculation unit 17 is incapable of calculating the position and the azimuth angle of the turning body 4. On the other hand, when the intensity of the GNSS radio wave is sufficient and the reception state of the GNSS radio wave is good, the first position/azimuth calculation 17 is highly likely to be in a state in which the first position/azimuth calculation unit 17 is capable of calculating the position and the azimuth angle of the turning body 4.

When the reception state of the GNSS radio wave has changed from the good state to the bad state, the switching unit 20 switches the calculation mode from the first calculation mode to the second calculation mode. When the first position/azimuth calculation unit 17 has changed from the state in which the first position/azimuth calculation unit 17 is capable of calculating the position and the azimuth angle of the turning body 4 to the state in which the first position/azimuth calculation unit 17 is incapable of calculating the position and the azimuth angle of the turning body 4, the switching unit 20 switches the calculation mode from the first calculation mode to the second calculation mode.

When the reception state of the GNSS radio wave has changed from the bad state to the good state, the switching unit 20 switches the calculation mode from the second calculation mode to the first calculation mode. Further, when the first position/azimuth calculation unit 17 has changed from the state in which the first position/azimuth calculation 17 is incapable of calculating the position and the azimuth angle of the turning body 4 to the state in which the first position/azimuth calculation 17 is capable of calculating the position and the azimuth angle of the turning body 4, the switching unit 20 switches the calculation mode from the second calculation mode to the first calculation mode.

In the embodiment, the display control unit 22 causes the display device 8A to display the reception state of the GNSS radio wave. As illustrated in FIG. 5, when the reception state of the GNSS radio wave has changed from the good state to the bad state, the display control unit 22 may cause the display device 8A to display that the reception state of the GNSS radio wave is bad. The operator can recognize, based on display data displayed on the display device 8A, that the reception state of the GNSS radio wave is bad. In the embodiment, the switching of the calculation mode from the first calculation mode to the second calculation mode may be implemented based on operation of the input device 8B by the operator. The operator who has recognized that the reception state of the GNSS radio wave is bad operates the input device 8B to generate input data for implementing the switching of the calculation mode from the first calculation mode to the second calculation mode. The switching unit 20 switches the calculation mode from the first calculation mode to the second calculation mode based on the input data from the input device 8B.

When the calculation mode has been switched from the first calculation mode to the second calculation mode, the display control unit 22 may cause the display device 8A to display that the calculation mode has been switched from the first calculation mode to the second calculation mode. Consequently, the operator can recognize that the calculation mode has been switched from the first calculation mode to the second calculation mode.

On the other hand, when the reception state of the GNSS radio wave has changed from the bad state to the good state, the display control unit 22 causes the display device 8A to display that the reception state of the GNSS radio wave is good. The operator can recognize, based on the display data displayed on the display device 8A, that the reception state of the GNSS radio wave is good. The switching of the calculation mode from the second calculation mode to the first calculation mode may be implemented based on the operation of the input device 8B by the operator. The operator who has recognized that the reception state of the GNSS radio wave is good operates the input device 8B to generate input data for implementing switching of the calculation mode from the second calculation mode to the first calculation mode. The switching unit 20 switches the calculation mode from the second calculation mode to the first calculation mode based on the input data from the input device 8B.

When the calculation mode is switched from the second calculation mode to the first calculation mode, the display control unit 22 may cause the display device 8A to display that the calculation mode has been switched from the second calculation mode to the first calculation mode. Consequently, the operator can recognize that the calculation mode has been switched from the second calculation mode to the first calculation mode.

### [Target]

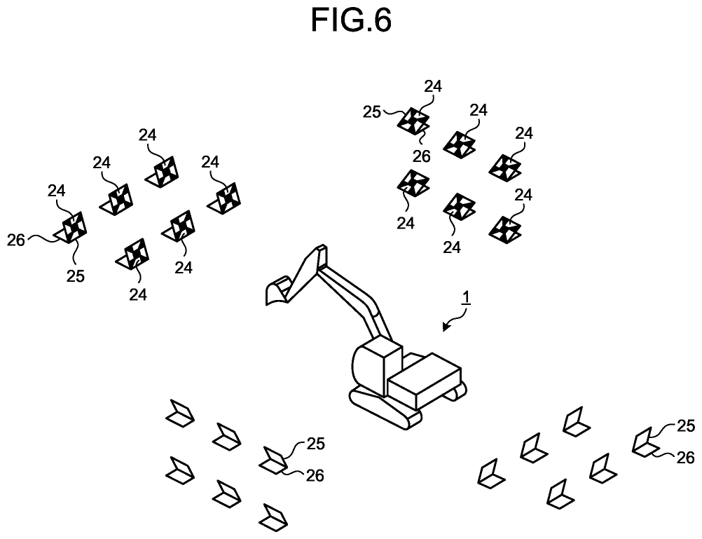

FIG. 6 is a diagram illustrating the targets 24 installed in the work site according to the embodiment. As illustrated in FIG. 6, the targets 24 are disposed on the outside of the excavator 1 in the work site. The plurality of targets 24 are disposed around the excavator 1 in the work site. The targets 24 include marks drawn on display plates 25. In the embodiment, grounding plates 26 are fixed to the lower end portions of the display plates 25. The display plates 25 are placed on the ground of the work site via the grounding plates 26. Note that the display plates 25 only have to be fixed to the work site. The targets 24 may be attached to, for example, structures in the work site. The targets 24 may be erected in the work site using members such as piles.

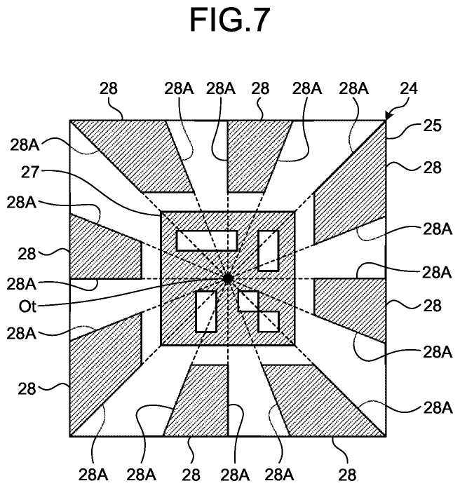

FIG. 7 is a diagram illustrating the target 24 according to the embodiment. The target 24 includes an identification mark 27 and a radiation mark 28 arranged around the identification mark 27. The identification mark 27 includes identification data for identifying the target 24. In embodiment, the identification mark 27 includes a two-dimensional barcode that identifies the target 24. A reference point Ot is defined in the target 24. The radiation mark 28 extends in the radiation direction from the reference point Ot of the target 24. The radiation mark 28 include a plurality of lines 28A extending in the radiation direction from the reference point Ot of the target 24. The lines 28A include edges of the radiation mark 28. The reference point Ot of the target 24 is defined at an intersection of the plurality of lines 28A. After the target 24 has been installed in the work site, the position of the target 24 is surveyed by a surveying instrument. The surveying instrument measures a three-dimensional position of the target 24 in the site coordinate system. The three-dimensional position of the target 24 includes a three-dimensional position of the reference point Ot. The surveying instrument measures the three-dimensional position of the reference point Ot. The three-dimensional position of each of the plurality of targets 24 measured by the surveying instrument is stored in the storage unit 16. The storage unit 16 stores correlation data indicating a relation between the identification data of the target 24 defined by the identification mark 27 and the three-dimensional position of the target 24 measured by the surveying instrument. The target 24 is specified based on the identification mark 27, whereby a three-dimensional position of the specified target 24 is identified.

### [Second Calculation Mode]

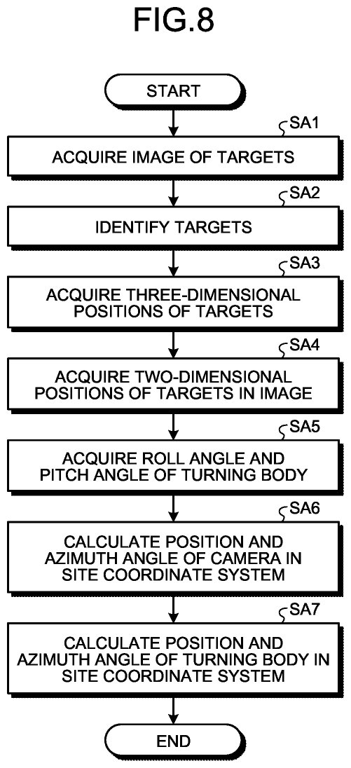

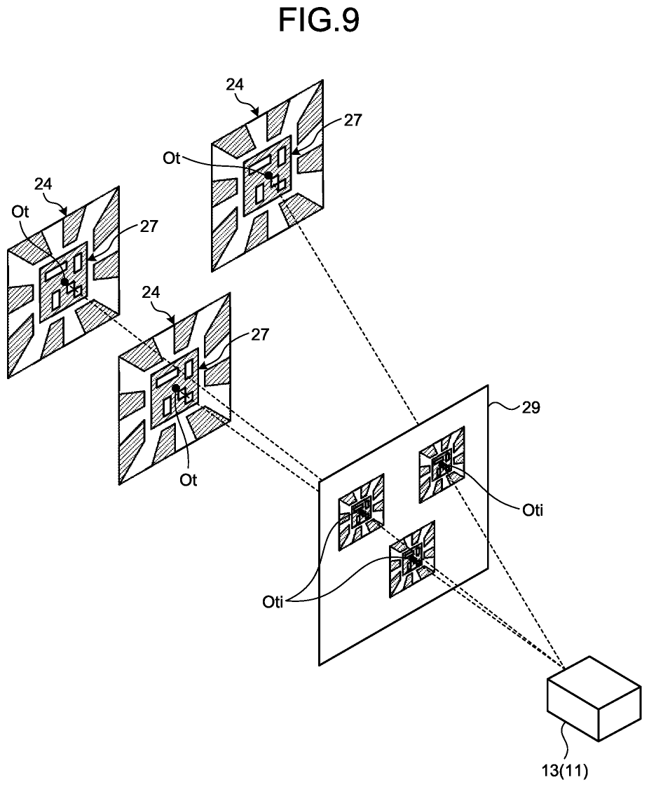

Next, a method of calculating a position and an azimuth angle of the turning body 4 in the second calculation mode is explained. FIG. 8 is a flowchart illustrating a method of calculating a position and an azimuth angle of the turning body 4 according to the embodiment. FIG. 9 is a schematic diagram for explaining the method of calculating a position and an azimuth angle of the turning body 4 according to the embodiment.

When a position and an azimuth angle of the turning body 4 cannot be calculated in the first calculation mode, the position and the azimuth angle of the turning body 4 are calculated in the second calculation mode. In the embodiment, the second position/azimuth calculation unit 18 calculates the position and the azimuth angle of the turning body 4 based on an image of the plurality of targets 24 and an inclination angle of the turning body 4. The second position/azimuth calculation unit 18 acquires an image of the plurality of targets 24 from the imaging device 11. The second position/azimuth calculation unit 18 acquires the inclination angle of the turning body 4 from the inclination angle calculation unit 19. As explained above, the inclination angle of the turning body 4 includes a roll angle and a pitch angle of the turning body 4.

The plurality of targets 24 are imaged by the imaging device 11. The imaging device 11 simultaneously images the plurality of targets 24. As illustrated in FIG. 9, three targets 24 are simultaneously imaged by the imaging device 11. The second position/azimuth calculation unit 18 acquires an image 29 of the three targets 24 imaged by the imaging device 11 (step SA1).

As illustrated in FIG. 9, the three targets 24 are arranged in one image 29.

The second position/azimuth calculation unit 18 identifies the targets 24 based on identification data defined by the identification marks 27 of the target 24 (step SA2).

The second position/azimuth calculation unit 18 specifies the targets 24 based on the identification marks 27 in the image 29. The second position/azimuth calculation unit 18 acquires three-dimensional positions of the targets 24 from the storage unit 16 based on the identification marks 27 in the image 29 and the correlation data stored in the storage unit 16 (step SA3).

As explained above, the three-dimensional positions of the targets 24 are measured beforehand by the surveying instrument and stored in the storage unit 16. Correlation data indicating a relation between the identification data defined by the identification marks 27 of the targets 24 and the three-dimensional positions of the targets 24 is stored in advance in the storage unit 16. Therefore, the second position/azimuth calculation unit 18 can acquire the three-dimensional positions of the targets 24 based on the identification marks 27 in the image 29 and the correlation data stored in the storage unit 16.

The second position/azimuth calculation unit 18 acquires two-dimensional positions of the targets 24 in the image 29 (step SA4).

The two-dimensional positions of the targets 24 in the image 29 include two-dimensional positions of the reference points Ot defined in the targets 24. As explained above, the targets 24 have the radiation marks 28 including the lines 28A. The second position/azimuth calculation unit 18 calculates the two-dimensional positions of the reference points Ot in the image 29 based on the radiation marks 28 in the image 29. The second position/azimuth calculation unit 18 can highly accurately calculate the two-dimensional positions of the reference points Ot in the image 29 based on the radiation marks 28 by performing image processing on the image 29 of the targets 24. In the following explanation, the reference points Ot in the image 29 is referred to as reference points Oti as appropriate.

The inclination angle calculation unit 19 acquires detection data of the inclination sensor 10 at the time when the targets 24 are imaged and calculates a pitch angle and a roll angle of the turning body 4 at the time when the targets 24 are imaged. The second position/azimuth calculation unit 18 acquires the roll angle and the pitch angle of the turning body 4 at the time when the targets 24 are imaged from the inclination angle calculation unit 19 (step SA5).

The second position/azimuth calculation unit 18 calculates a position and an azimuth angle of the camera 13 in the site coordinate system based on the three-dimensional positions of the three targets 24 acquired in step SA3, the two-dimensional positions of the targets 24 in the image 29 acquired in step SA4, and the roll angle and the pitch angle of the turning body 4 acquired in step SA5 (step SA6).

In the embodiment, the second position/azimuth calculation unit 18 calculates the position and the azimuth angle of the camera 13 in the site coordinate system based on a bundling method which is a type of block adjustment method in aerial triangulation. The aerial triangulation means a method of calculating an imaging position and an imaging direction of each of a plurality of images 29 by a plurality of cameras 13 based on known coordinates of the reference points Ot using a collinear condition indicating straightness of light and a geometric property of an aerial photograph.

In order to calculate the position and the azimuth angle of the camera 13 based on the bundling method, the second position/azimuth calculation unit 18 acquires three-dimensional positions of the three reference points Ot, two-dimensional positions of the reference points Oti in the image 29, and a roll angle and a pitch angle of the turning body 4. The three-dimensional positions of the reference points Ot are three-dimensional positions in the site coordinate system. The two-dimensional positions of the reference points Oti are two-dimensional positions in the image coordinate system defined in the image 29. The image coordinate system is represented by a uv coordinate system in which an upper left corner of the image 29 is set as an origin, a lateral direction is set as a u axis, and a longitudinal direction is set as a v axis. The two-dimensional positions of the reference points Oti function as pass points for combining overlapping portions of the plurality of images 29.

For example, when a three-dimensional position of the reference point Ot in the on-site coordinate system is represented as P (X, Y, Z), a three-dimensional position of the reference point Ot in the camera coordinate system is represented as Pc (Xc, Yc, Zc), a two-dimensional position of the reference point Oti in the image coordinate system is represented as p (x, y), a position of the optical center Oc in the site coordinate system is represented as O (Xo, Yo, Zo), a rotation matrix indicating a posture of the camera 13 in the site coordinate system is represented as R, and an internal parameter matrix is represented as k, the following conditions of Expression (1), Expression (2), and Expression (3) hold.

$$p = k \cdot Pc \qquad ( 1 )$$

$$P = R \cdot PC + O \qquad ( 2 )$$

$$P = R \cdot ( {k}^{- 1} \cdot p ) \qquad ( 3 )$$

The second position/azimuth calculation unit 18 can calculate the position and the azimuth angle of the camera 13 in the site coordinate system by performing convergence calculation on the three-dimensional positions of the three reference points Ot, the two-dimensional positions of the reference points Oti in the image 29, and the roll angle and the pitch angle of the turning body 4 based on the bundling method.

The second position/azimuth calculation unit 18 calculates a position and an azimuth angle of the turning body 4 in the site coordinate system based on the position and the azimuth angle of the camera 13 calculated in step SA6 (step SA7).

Relative positions of the optical center Oc of the camera 13 and the representative point Om of the turning body 4 is known. A conversion matrix for converting the vehicle body coordinate system based on the representative point Om defined in the turning body 4 and the camera coordinate system based on the optical center Oc of the camera 13 is known. Therefore, the second position/azimuth calculation unit 18 can calculate the position and the azimuth angle of the turning body 4 in the site coordinate system by calculating the position and the azimuth angle of the camera 13 in the site coordinate system based on the bundling method using the image 29 obtained by imaging the targets 24 and coordinate-converting the position and the azimuth angle of the camera 13 based on the conversion matrix.

The processing in step SA1 to step SA7 explained above is implemented when the targets 24 are imaged. When the position and the azimuth angle of the turning body 4 are calculated after the traveling body 3 has performed the traveling motion, the processing in steps SA1 to SA7 explained above is executed again.

Note that, in the processing in step SA1 to step SA7 explained above, the three targets 24 may not be imaged and at least two targets 24 only have to be imaged.

[Calculation of a Position and an Azimuth after a Turning Motion]

After the position and the azimuth angle of the turning body 4 have been calculated, when the traveling body 3 performs traveling motion, the targets 24 are imaged in order to calculate a position and an azimuth angle of the turning body 4. When the targets 24 are imaged, the processing in step SA1 to step SA7 explained above is executed again.

On the other hand, after the position and the azimuth angle of the turning body 4 have been calculated by the processing in step SA1 to step SA7 explained above, when the traveling body 3 has not performed the traveling motion and the turning body 4 has performed the turning motion, the second position/azimuth calculation unit 18 can calculate a position and an azimuth angle of the turning body 4 based on the image 29 of at least one target 24 without using at least two targets 24.

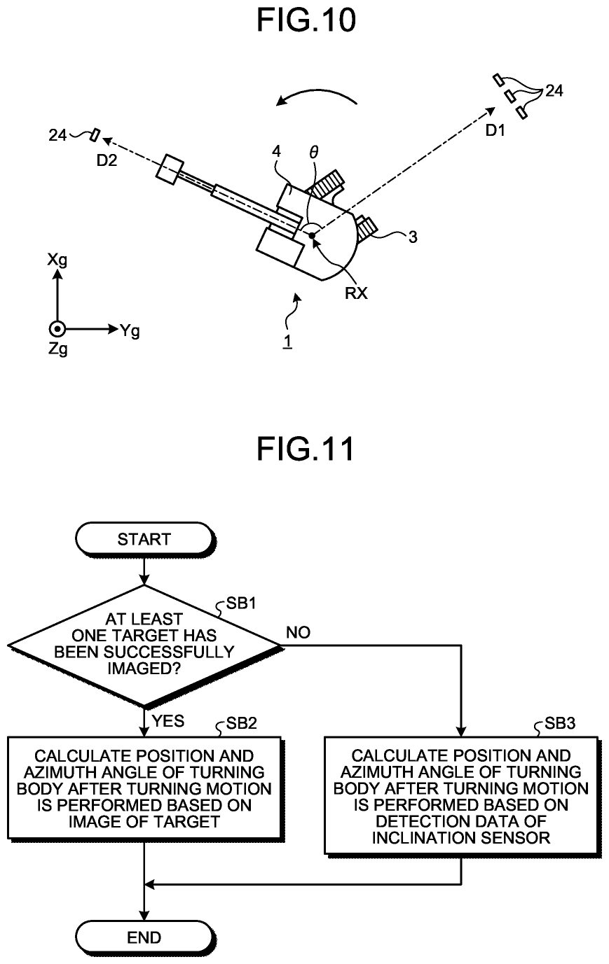

FIG. 10 is a schematic diagram for explaining a method of calculating a position and an azimuth angle of the turning body 4 according to the embodiment. When at least two targets 24 are imaged in a state where the turning body 4 faces a first direction D1, a position and an azimuth of the turning body 4 are calculated according to the processing in step SA1 to step SA7 explained above.

After the position and the azimuth angle of the turning body 4 have been calculated, when the turning body 4 turns from the first direction D1 to face a second direction D2 and at least one target 24 is imaged by the imaging device 11, the azimuth angle of the turning body 4 at the time when the turning body 4 faces the second direction D2 is calculated based on the image 29 of the at least one target 24. After calculating the position and the azimuth angle of the turning body 4 using the at least two targets 24, when the turning body 4 performs a turning motion centering on the turning axis RX to face the second direction D2 from the first direction D1, the second position/azimuth calculation unit 18 can calculate a position and an azimuth angle of the turning body 4 based on the image 29 of the at least one target 24 captured by the imaging device 11.

That is, the second position/azimuth calculation unit 18 calculates a turning angle θ based on the azimuth angle of the turning body 4 before the turning motion calculated using the at least two targets 24 present in the first direction D1, the image 29 of one target 24 present in the second direction D2, the roll angle and the pitch angle of the turning body 4 before the turning motion, and the roll angle and the pitch angle of the turning body 4 after the turning motion. By calculating the turning angle θ, the second position/azimuth calculation unit 18 can calculate an azimuth angle of the turning body 4 after the turning motion based on the azimuth angle of the turning body 4 and the turning angle θ calculated using the at least two targets 24. When the traveling body 3 is not performing the traveling motion, the position of the turning axis RX does not change. Therefore, the second position/azimuth calculation unit 18 can calculate the position of the turning body 4 based on the calculated turning angle θ.

The second position/azimuth calculation unit 18 may simultaneously calculate the position of the turning axis RX, the azimuth angle of the turning body 4 before the turning body 4 performs the turning motion, and the azimuth angle of the turning body 4 after the turning body 4 has performed the turning motion based on the image 29 of at least two targets 24 imaged by the imaging device 11 before the turning body 4 performs the turning motion, the roll angle and the pitch angle of the turning body 4 before the turning body 4 performs the turning motion, the image 29 of at least one target 24 captured by the imaging device 11 after the turning body 4 has performed the turning motion, and the roll angle and the pitch angle of the turning body 4 after the turning body 4 has performed the turning motion.

Note that the second position/azimuth calculation unit 18 can calculate the turning angle θ based on the detection data of the inclination sensor 10. As explained above, the inclination sensor 10 includes the inertial measurement unit (IMU). The inertial measurement unit (IMU) functions as a turning sensor that detects turning of the turning body 4. The second position/azimuth calculation unit 18 can calculate the turning angle θ based on detection data of the inertial measurement unit (IMU). Therefore, after calculating the position and the azimuth angle of the turning body 4 using the three targets 24, when the traveling body 3 has not performed the traveling motion and the turning body 4 has performed the turning motion, the second position/azimuth calculation unit 18 can calculate, based on the detection data of the inclination sensor 10 that detects the turning of the turning body 4, the position and the azimuth angle of the turning body 4 after the performing the turning motion.

FIG. 11 is a flowchart illustrating a method of calculating a position and an azimuth angle of the turning body 4 after the turning body 4 according to the embodiment has performed the turning motion. After the turning body 4 has performed the turning motion, the second position/azimuth calculation unit 18 determines whether the imaging device 11 has successfully imaged the targets 24. That is, the second position/azimuth calculation unit 18 determines whether an image of at least one target 24 has been successfully acquired after the turning body 4 has performed the turning motion (step SB1).

When determining in step SB1 that the image of at least one target 24 has been successfully acquired (step SB1: Yes), the second position/azimuth calculation unit 18 calculates an azimuth angle of the turning body 4 after the turning motion is performed based on the image 29 of at least one target 24, the roll angle and the pitch angle of the turning body 4 before performing the turning motion, and the roll angle and the pitch angle of the turning body 4 after the turning motion is performed (step SB2).

When determining in step SB1 that the image of at least one target 24 has not be successfully acquired (step SB1: No), the second position/azimuth calculation unit 18 calculates, based on the detection data of the inclination sensor 10 that detects the turning of the turning body 4, the position and the azimuth angle of the turning body 4 after the turning motion is performed (step SB3).

As explained above, when the first position/azimuth calculation unit 17 is in the state of being incapable of calculating a position and an azimuth angle of the turning body 4 and the imaging device 11 images at least two targets 24 before the turning body 4 performs the turning motion, the second position/azimuth calculation unit 18 calculates the position and the azimuth angle of the turning body 4 based on the image 29 of the at least two targets 24 and the inclination angle of the turning body 4. When the first position/azimuth calculation unit 17 is in the state of being incapable of calculating a position and an azimuth angle of the turning body 4 and the traveling body 3 has not performed the traveling motion and the turning body 4 has performed the turning motion, the second position/azimuth calculation unit 18 can calculate the position and the azimuth angle of the turning body 4 based on the image 29 of at least one target 24 acquired by the imaging device 11 after the turning body 4 has performed the turning motion or the detection data of the inclination sensor 10 after the turning body 4 has performed the turning motion.

### [Processing of the Correction Unit]

Next, processing of the correction unit 23 is explained. The correction unit 23 corrects an error of the inclination sensor 10. As explained above, after the traveling body 3 has not performed the traveling motion and the turning body 4 has performed the turning motion, when the position and the azimuth angle of the turning body 4 cannot be calculated based on the detection data of the position sensor 9 and the position and the azimuth angle of the turning body 4 cannot be calculated based on the image 29 of the at least one target 24, the second position/azimuth calculation unit 18 can calculate, based on the detection data of the inclination sensor 10 including the IMU, the position and the azimuth angle of the turning body 4 after the turning motion is performed. When the position and the azimuth angle of the turning body 4 are calculated, after the turning motion is performed, using the detection data of the inclination sensor 10, acceleration detected by the inclination sensor 10 is double-integrated by time, whereby the position of the turning body 4 is calculated, and angular velocity detected by the inclination sensor 10 is integrated by time, whereby the azimuth angle of the turning body 4 is calculated. When the detection data of the inclination sensor 10 is integrated, it is likely that a cumulative error is caused in calculation results of the position and the azimuth angle of the turning body 4 by integral addition. That is, it is likely that errors due to integration of the acceleration or the angular velocity accumulate and calculation accuracy of the position and the azimuth angle of the turning body 4 is deteriorated.

When the reception state of the GNSS radio wave is good and the first position/azimuth calculation unit 17 is in the state of being capable of calculating a position and an azimuth angle of the turning body 4, the correction unit 23 can correct errors in the position and the azimuth angle of the turning body 4 based on a calculation result of the first position/azimuth calculation unit 17.

On the other hand, when the reception state of the GNSS radio wave is bad and the first position/azimuth calculation unit 17 is in the state of being incapable of calculating a position and an azimuth angle of the turning body 4, the correction unit 23 can correct errors in the position and the azimuth angle of the turning body 4 based on a calculation result of the second position/azimuth calculation unit 18.

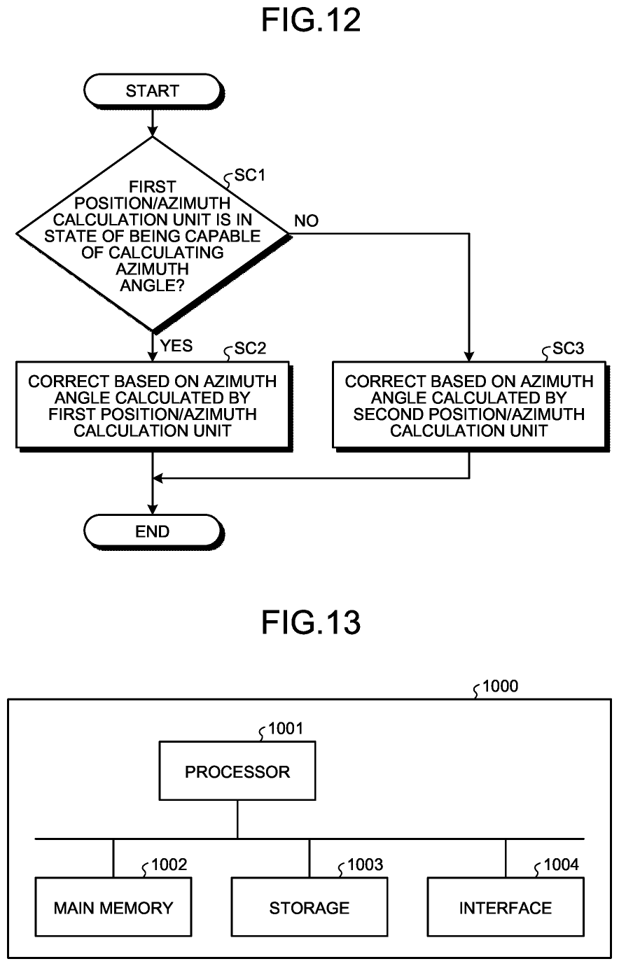

FIG. 12 is a flowchart illustrating a method of correcting a calculation result of a position and an azimuth angle of the turning body 4 according to the embodiment. The switching unit 20 determines whether the first position/azimuth calculation unit 17 is in a state of being capable of calculating an azimuth angle of the turning body 4 (step SC1).

When it is determined in step SC1 that the first position/azimuth calculation unit 17 is in the state of being capable of calculating an azimuth angle of the turning body 4 (step SC1: Yes), the correction unit 23 corrects errors of a position and an azimuth angle of the turning body 4 based on the azimuth angle of the turning body 4 calculated by the first position/azimuth calculation unit 17 (step SC2).

When it is determined in step SC1 that the first position/azimuth calculation unit 17 is in a state of being incapable of calculating an azimuth angle of the turning body 4 (step SC1: No), the correction unit 23 corrects errors of the position and an azimuth angle of the turning body 4 based on the azimuth angle of the turning body 4 calculated by the second position/azimuth calculation unit 18 (step SC3).

### [Computer System]

FIG. 13 is a block diagram illustrating a computer system 1000 according to the embodiment. The control device 12 explained above includes the computer system 1000. The computer system 1000 includes a processor 1001 such as a CPU (Central Processing Unit), a main memory 1002 including a nonvolatile memory such as a ROM (Read Only Memory) and a volatile memory such as a RAM (Random Access Memory), a storage 1003, and an interface 1004 including an input and output circuit. The function of the control device 12 explained above is stored in the storage 1003 as a computer program. The processor 1001 reads the computer program from the storage 1003, loads the computer program in the main memory 1002, and executes the processing explained above according to the program. Note that the computer program may be distributed to the computer system 1000 via a network.

The computer program or the computer system 1000 can execute, according to the embodiment explained above, calculating a position and an azimuth angle of the excavator 1 in a first calculation mode based on a GNSS radio wave, calculating a position and an azimuth angle of the excavator 1 in a second calculation mode based on an image of the plurality of targets 24 installed on the outside of the excavator 1, and switching the first calculation mode and the second calculation mode.

### Effects

As explained above, according to the embodiment, the position and the azimuth angle of the excavator 1 are calculated in the first calculation mode based on the GNSS radio wave. The position and the azimuth angle of the excavator 1 are calculated in the second calculation mode based on the image 29 of the plurality of targets 24 installed on the outside of the excavator 1. The first calculation mode and the second calculation mode are switched by the switching unit 20. Even if a positioning failure of the GNSS occurs and the position and the azimuth angle of the excavator 1 cannot be calculated in the first calculation mode, the position and the azimuth angle of the excavator 1 are calculated in the second calculation mode. Therefore, even if a positioning failure of the GNSS occurs, the excavator 1 can implement work based on a machine guidance technology or a machine control technology.

The switching unit 20 switches the first calculation mode and the second calculation mode based on a reception state of the GNSS radio wave. When the reception state of the GNSS radio wave has changed from the good state to the bad state, the calculation mode is switched from the first calculation mode to the second calculation mode. When the reception state of the GNSS radio wave has changed from the bad state to the good state, the calculation mode is switched from the second calculation mode to the first calculation mode. Consequently, the position and the azimuth angle of the excavator 1 are always calculated.

The switching unit 20 switches between the first calculation mode and the second calculation mode based on whether the position and the azimuth angle of the excavator 1 can be calculated in the first calculation mode. When a state in which the position and the azimuth angle of the excavator 1 can be calculated in the first calculation mode has changed to a state in which the position and the azimuth angle cannot be calculated in the first calculation mode, the calculation mode is switched from the first calculation mode to the second calculation mode. When the state in which the position and the azimuth angle of the excavator 1 cannot be calculated in the first calculation mode has changed to the state in which the position and the azimuth angle can be calculated in the first calculation mode, the calculation mode is switched from the second calculation mode to the first calculation mode. Consequently, the position and the azimuth angle of the excavator 1 are always calculated.

The reception state of the GNSS radio wave is displayed on the display device 8A. Consequently, the operator of the excavator 1 can recognize the reception state of the GNSS radio wave by checking the display device 8A.

The first calculation mode and the second calculation mode are switched based on input data from the input device 8B. Consequently, the first calculation mode and the second calculation mode are switched based on an intention of the operator of the excavator 1.

It is displayed on the display device 8A that the first calculation mode and the second calculation mode have been switched. Consequently, by checking the display device 8A, the operator of the excavator 1 can recognize that the first calculation mode and the second calculation mode have been switched.

The display device 8A is disposed in the cab 2 of the excavator 1. Consequently, the operator of the excavator 1 can smoothly check the display device 8A.

An inclination angle of the excavator 1 is calculated based on detection data of the inclination sensor 10 disposed in the excavator 1. Consequently, the second position/azimuth calculation unit 18 can calculate the position and the azimuth angle of the excavator 1 based on the image 29 of the plurality of targets 24 and the inclination angle of the excavator 1.

When the first position/azimuth calculation unit 17 is in a state of being incapable of calculating the position and the azimuth angle of the turning body 4 and the traveling body 3 has not performed the traveling motion and the turning body 4 has performed the turning motion, the second position/azimuth calculation unit 18 can calculate the position and the azimuth angle of the turning body 4 based on the image 29 of at least one target 24 acquired after the turning body 4 has performed the turning motion or the detection data of the inclination sensor 10 after the turning body 4 has turned.

When the inclination sensor 10 includes an inertial measurement unit (IMU), the inclination sensor 10 can detect the azimuth angle of the excavator 1. When the first position/azimuth calculation unit 17 can calculate the position and the azimuth angle of the excavator 1, the correction unit 23 can correct errors in the position and the azimuth angle of the turning body 4 on the basis of the azimuth angle of the excavator 1 calculated in the first calculation mode. In the state in which the first position/azimuth calculation unit 17 is incapable of calculating the position and the azimuth angle of the excavator 1, the correction unit 23 can correct errors of the position and the azimuth angle of the turning body 4 based on the azimuth angle of the excavator 1 calculated in the second calculation mode.

### Other Embodiments

In the embodiment explained above, the second position/azimuth calculation unit 18 calculates the position and the azimuth angle of the camera 13 in the site coordinate system based on the three reference points Ot. The second position/azimuth calculation unit 18 may calculate the position and the azimuth angle of the camera 13 in the site coordinate system based on the at least two reference points Ot. That is, the second position/azimuth calculation unit 18 may calculate the position and the azimuth angle of the camera 13 in the site coordinate system by performing convergence calculation on the three-dimensional positions of the at least two reference points Ot, the two-dimensional positions of the reference points Oti in the image 29, and the roll angle and the pitch angle of the turning body 4.

In the embodiment explained above, the second position/azimuth calculation unit 18 calculates the position and the azimuth angle of the camera 13 in the site coordinate system and calculates the position and the azimuth angle of the turning body 4 in the site coordinate system. The second position/azimuth calculation unit 18 may calculate the position and the azimuth angle of the camera 13 in the vehicle body coordinate system or may calculate the position and the azimuth angle of the camera 13 in the camera coordinate system. The second position/azimuth calculation unit 18 may calculate the position and azimuth angle of the turning body 4 in the vehicle body coordinate system or may calculate the position and azimuth angle of the turning body 4 in the camera coordinate system.

In the embodiment explained above, the target 24 is imaged by the stereo camera 15. The target 24 may be imaged by a monocular camera.

In the embodiment explained above, the in-vehicle monitor 8 includes the display device 8A and the input device 8B. For example, the tablet terminal may include the display device 8A and the input device 8B. That is, the display device 8A and the input device 8B may be separated from the excavator 1. In the embodiment explained above, the display device 8A and the input device 8B are disposed in the cab 2. One or both of the display device 8A and the input device 8B may be disposed on the outside of the cab 2.

In the embodiment explained above, the reception state of the GNSS radio wave is displayed on the display device 8A. The display control unit 22 may cause the display device 8A to display, for example, recommendation display data for recommending switching between the first calculation mode and the second calculation mode. For example, when the reception state of the GNSS radio wave has changed from the good state to the bad state, the display control unit 22 may cause the display device 8A to display character data such as “it is recommended to switch the calculation mode from the first calculation mode to the second calculation mode”. When the reception state of the GNSS radio wave has changed from the bad state to the good state, the display control unit 22 may cause the display device 8A to display character data such as “it is recommended to switch the calculation mode from the second calculation mode to the first calculation mode”.

In the embodiment explained above, the switching of the first calculation mode and the second calculation mode is implemented based on the operation of the input device 8B by the operator. The reception state of the GNSS radio wave may not be displayed on the display device 8A. Switching of the first calculation mode and the second calculation mode may be automatically implemented by the control device 12. For example, when the reception state of the GNSS radio wave has changed from the good state to the bad state, the switching unit 20 may automatically switch the calculation mode from the first calculation mode to the second calculation mode irrespective of the input data from the input device 8B. When the reception state of the GNSS radio wave has changed from the bad state to the good state, the switching unit 20 may automatically switch the calculation mode from the second calculation mode to the first calculation mode irrespective of the input data from the input device 8B. When the first calculation mode and the second calculation mode are automatically switched, the display control unit 22 may cause the display device 8A to display that the first calculation mode and the second calculation mode are switched.

In the embodiment explained above, each of the storage unit 16, the first position/azimuth calculation unit 17, the second position/azimuth calculation unit 18, the inclination angle calculation unit 19, the switching unit 20, the three-dimensional data calculation unit 21, the display control unit 22, and the correction unit 23 may be configured by different hardware.

In the embodiment explained above, the work machine 1 is an excavator including the traveling body 3 and the turning body 4. The work machine 1 may not include the traveling body 3 and the turning body 4. The work machine 1 only has to include working equipment and may be, for example, a bulldozer or a wheel loader.

### REFERENCE SINGS LIST

1 EXCAVATOR (WORK MACHINE)
2 CAB
3 TRAVELING BODY
3A CRAWLER BELT
4 TURNING BODY
5 WORKING EQUIPMENT
5A BOOM
5B ARM
5C BUCKET
6 HYDRAULIC CYLINDER
6A BOOM CYLINDER
6B ARM CYLINDER
6C BUCKET CYLINDER
7 OPERATION DEVICE
7A LEFT WORK LEVER
7B RIGHT WORK LEVER
7C LEFT TRAVELING LEVER
7D RIGHT TRAVELING LEVER
7E LEFT FOOT PEDAL
7F RIGHT FOOT PEDAL
8 IN-VEHICLE MONITOR
8A DISPLAY DEVICE
8B INPUT DEVICE
9 POSITION SENSOR
9A FIRST POSITION SENSOR
9B SECOND POSITION SENSOR
10 INCLINATION SENSOR
11 IMAGING DEVICE
12 CONTROL DEVICE
13 CAMERA
13A CAMERA
13B CAMERA
13C CAMERA
13D CAMERA
14 DRIVER'S SHEET
15 STEREO CAMERA
15A STEREO CAMERA
15B STEREO CAMERA
16 STORAGE UNIT
17 FIRST POSITION/AZIMUTH CALCULATION UNIT
18 SECOND POSITION/AZIMUTH CALCULATION UNIT
19 INCLINATION ANGLE CALCULATION UNIT
20 SWITCHING UNIT
21 THREE-DIMENSIONAL DATA CALCULATION UNIT
22 DISPLAY CONTROL UNIT
23 CORRECTION UNIT
24 TARGET
25 DISPLAY PLATE
26 GROUNDING PLATE
27 IDENTIFICATION MARK
28 RADIATION MARK
28A LINE
29 IMAGE
30 CONTROL SYSTEM
1000 COMPUTER SYSTEM
1001 PROCESSOR
1002 MAIN MEMORY
1003 STORAGE
1004 INTERFACE
D1 FIRST DIRECTION
D2 SECOND DIRECTION
Oc OPTICAL CENTER
Ot REFERENCE POINT
Og SITE REFERENCE POINT
Om REPRESENTATIVE POINT
Oti REFERENCE POINT
RX TURNING AXIS
θ TURNING ANGLE

1. A control system of a work machine, comprising:
a first position/azimuth calculation unit that calculates a position and an azimuth angle of the work machine based on a GNSS radio wave;
a second position/azimuth calculation unit that calculates the position and the azimuth angle of the work machine based on an image of a plurality of targets installed on an outside of the work machine; and
a switching unit that switches a first calculation mode in which the first position/azimuth calculation unit calculates the position and the azimuth angle of the work machine and a second calculation mode in which the second position/azimuth calculation unit calculates the position and the azimuth angle of the work machine.

2. The control system of the work machine according to claim 1, wherein
the switching unit switches the first calculation mode and the second calculation mode based on a reception state of the GNSS radio wave.

3. The control system of the work machine according to claim 1 or 2, wherein
the switching unit switches the first calculation mode and the second calculation mode based on whether the first position/azimuth calculation unit can calculate the position and the azimuth angle of the work machine.

4. The control system of the work machine according to any one of claims 1 to 3, comprising
a display control unit that causes a display device to display a reception state of the GNSS radio wave.

5. The control system of the work machine according to claim 4, wherein
the switching unit switches the first calculation mode and the second calculation mode based on input data from an input device.

6. The control system of the work machine according to any one of claims 1 to 3, comprising
a display control unit that causes a display device to display that the first calculation mode and the second calculation mode have been switched.

7. The control system of the work machine according to any one of claims 1 to 3, comprising
a display control unit that causes a display device to display that switching of the first calculation mode and the second calculation mode is recommended.

8. The control system of the work machine according to any one of claims 4 to 7, wherein
the display device is disposed in a cab (2) of the work machine.

9. The control system of the work machine according to any one of claims 1 to 8, comprising:
an inclination sensor disposed in the work machine; and
an inclination angle calculation unit that calculates an inclination angle of the work machine based on detection data of the inclination sensor, wherein
the second position/azimuth calculation unit calculates the position and the azimuth angle of the work machine based on an image of a plurality of targets and the inclination angle of the work machine.

10. The control system of the work machine according to claim 9, wherein
the work machine includes a traveling body and a turning body,
the inclination sensor is disposed in the turning body,
the position and the azimuth angle of the work machine are a position and an azimuth angle of the turning body, and
when the first position/azimuth calculation unit is in a state of being incapable of calculating the position and the azimuth angle of the turning body and the traveling body has not performed a traveling motion and the turning body has performed a turning motion, the second position/azimuth calculation unit calculates the position and the azimuth angle of the turning body based on an image of at least one target acquired after the turning body has performed the turning motion.

11. The control system of the work machine according to claim 9, wherein
the work machine includes a traveling body and a turning body,
the inclination sensor is disposed in the turning body,
the position and the azimuth angle of the work machine are a position and an azimuth angle of the turning body, and
when the first position/azimuth calculation unit is in a state of being incapable of calculating the position and the azimuth angle of the turning body and the traveling body has not performed a traveling motion and the turning body has performed a turning motion, the second position/azimuth calculation unit calculates the position and the azimuth angle of the turning body based on detection data obtained by the inclination sensor after the turning body has performed the turning motion.

12. The control system of the work machine according to claim 10 or 11, comprising
a correction unit that corrects an error of the inclination sensor, wherein
the correction unit corrects errors of the position and azimuth angle of the turning body based on a calculation result of the first position/azimuth calculation unit in a state where the first position/azimuth calculation unit is capable of calculating the position and the azimuth angle of the work machine and corrects the errors of the position and the azimuth angle of the turning body based on a calculation result of the second position/azimuth calculation unit in a state where the first position/azimuth calculation unit is incapable of calculating the position and the azimuth angle of the work machine.

13. The control system of the work machine according to any one of claims 1 to 11, wherein
the work machine includes a traveling body and a turning body, and
the position and the azimuth angle of the work machine are a position and an azimuth angle of the turning body.

14. A work machine comprising
the control system of the work machine according to any one of claims 1 to 13.

15. A method of controlling a work machine, comprising:
calculating a position and an azimuth angle of the work machine in a first calculation mode based on a GNSS radio wave;
calculating the position and the azimuth angle of the work machine in a second calculation mode based on an image of a plurality of targets installed on an outside of the work machine;
switching the first calculation mode and the second calculation mode.

16. The method of controlling the work machine according to claim 15, wherein
the first calculation mode and the second calculation mode are switched based on a reception state of the GNSS radio wave.

17. The method of controlling the work machine according to claim 15 or 16, wherein
the first calculation mode and the second calculation mode are switched based on whether the position and the azimuth angle of the work machine can be calculated in the first calculation mode.

18. The method of controlling the work machine according to any one of claims 15 to 17, comprising
displaying a reception state of the GNSS radio wave on a display device.

19. The method of controlling the work machine according to claim 18, wherein
the first calculation mode and the second calculation mode are switched based on input data from an input device.

20. The method of controlling the work machine according to any one of claims 15 to 17, comprising
displaying, on a display device, that the first calculation mode and the second calculation mode have been switched.
